(19) United States
(12) Patent Application Publication
(10) Pub. No.: US 2026/0245501 A1
(43) Pub. Date: Aug. 20, 2026

(54) SYSTEM AND METHOD OF A MICRO-LED PIXEL DIGITAL DRIVING CIRCUIT

(71) Applicant: Jade Bird Display (Shanghai) Limited, Shanghai (CN)

(72) Inventors: Jing JU, Shanghai (CN); Hongyun LIU, Shanghai (CN); Chunming LI, Shanghai (CN)

(21) Appl. No.: 19/486,866

(22) PCT Filed: Apr. 14, 2023
(86) PCT No.: PCT/CN2023/088272

§ 371 Date: Nov. 21, 2025

(51) Int. Cl. G09G 3/32; G09G 3/20

(52) U.S. Cl. CPC G09G 3/32; G09G 3/2022; G09G 3/2096; G09G 2310/08; G09G 2320/0242; G09G 2360/18

(57) ABSTRACT

A micro-LED pixel digital driving circuit is disclosed herein, that comprises micro-LED pixels, a time sequence control circuit module, a data buffer conversion module, and a reference current supply module. The reference current supply module is in current supply connection with the micro-LED pixels; the time sequence control circuit module comprises a time sequence control unit, a subframe control unit and one or more subframe control switches. The data buffer conversion module comprises an external data input port, a memory, and one or more data transmission switches. The gates of data transmission switches are connected to the data output ports of the memory respectively. The external data input port is arranged on the input end of the memory. The digital micro-LED pixel driving system disclosed herein drives the micro-LED pixels to display images on a display screen.

### TECHNICAL FIELD

The present disclosure relates generally to the technical field of displays, in particular to a micro light-emitting diode (LED) pixel digital driving circuit and system, and a process of driving the micro-LED pixel digital driving system.

### BACKGROUND

Display technologies are becoming increasingly important in today's commercial electronic devices. These display panels are widely used in stationary large screens such as liquid crystal display televisions (LCD TVs) and organic light emitting diode televisions (OLED TVs) as well as portable electronic devices such as laptop personal computers, smartphones, tablets and wearable electronic devices.

A Light-Emitting Diode (LED) chip generally includes an Organic Light-Emitting Diode (OLED) chip, a Mini Light-Emitting Diode (Sub-millimeter Light-Emitting Diode) chip or a Micro LED (Micro Meter Light-Emitting Diode) chip and the like. LED is widely applied in the field of illumination. As the LED display screen gradually permeates towards the high-end market, the light emitting efficiency requirement of the LED display screen device is higher.

Pixels are composed of small squares of an image, and the small squares have a clear position and are assigned color values, and the color and position of the small squares determine the appearance of the image. The pixels may be viewed as inseparable units or elements throughout the image. Inseparable means that a pixel cannot be further cut into smaller units or elements, which are present in a single-color cell. Each dot matrix image contains a quantity of pixels that determine the size of the image presented on the screen.

Micro-LED display technology relates to micron-scale LED pixel units, which are assembled to a driving panel to form a high-density LED display array. Since the Micro-LED chip has attributes such as small in size, high in integration level, self-luminous, etc., the Micro-LED chip has greater advantages in terms of brightness, resolution, contrast, energy consumption, service life, response speed, thermal stability and the like compared with an LCD and an OLED. In some approaches, the early LED display screen pixels are formed by combining LEDs with three primary colors of red, green and blue.

In some approaches, the pixel driving systems are also mainly based on technical considerations in image brightness driving and image display time sequence driving methods. Those approaches mainly comprise analog methods. In some technology about image brightness driving methods, the current flowing through the pixel LED is changed by changing the magnitude of the gate to source voltage Vgs in the circuit, so that the brightness of the pixel LED is controlled. Those methods mainly control the scanning time and sequence of the source images so as to realize the time sequence control on the display array.

Hence, the technical drawbacks in the LED pixel analog driving circuit in those approaches are that when the traditional analog driving mode is applied to the micro-LED field, the analog driving mode can cause the wavelength of the micro-LED to be continuously shifted. In addition, when the three monochromatic panels are used for synthesizing colors, the whiteness balance is difficult to achieve.

As such, it would be desirable to provide a light emitting pixel driving circuit for display panels that addresses the above-mentioned drawbacks, amongst others.

### SUMMARY

There is a need for improved display device designs that improve upon, and help to address the issues and shortcomings of conventional display systems, such as those described above. In particular, there is a need for a micro-LED pixel driving system with improved images.

The present disclosure relates to the technical field of displays, and discloses a Light-Emitting Diode (LED) pixel digital driving circuit and system, and a method of driving the micro-LED pixel digital driving system. The technical drawbacks of poor image characteristics from a pixel light-emitting unit at present is solved.

The present disclosure includes, without limitation, the following exemplary embodiments.

Some exemplary embodiments of the present disclosure provide a micro light-emitting digital driving circuit, which includes: one or more display micro-light-emitting-diode (micro-LED) pixels; a time sequence control circuit module; a data buffer conversion module; and a reference current supply module. In some examples, the time sequence control circuit module comprises a time sequence control unit, a subframe control unit and one or more subframe control switches; the data buffer conversion module comprises an external data input port, a memory and one or more data transmission switches; and the reference current supply module is configured to supply constant current to the one or more micro-LED pixels.

In some exemplary embodiments or any combination of exemplary embodiments of the micro light-emitting digital driving circuit, the data buffer conversion module further comprises a bit conversion unit arranged on a first input end of the memory, and configured for converting a bit data format of an input image data.

In some exemplary embodiments or any combination of exemplary embodiments of the micro light-emitting digital driving circuit, the number of the one or more subframe control switches and the number of the one or more data transmission switches are the same, and the number is configured to be n=2^{k}, wherein k is a non-negative integer.

In some exemplary embodiments or any combination of exemplary embodiments of the micro light-emitting digital driving circuit, the number of the one or more subframe control switches and the number of the one or more data transmission switches are the same, and the number is selected according to the number of bits of the input image data.

In some exemplary embodiments or any combination of exemplary embodiments of the micro light-emitting digital driving circuit, each of the one or more subframe control switches comprises a source electrode, a drain electrode, and a gate, and each of the one or more data transmission switches comprises a source electrode, a drain electrode, and a gate.

In some exemplary embodiments or any combination of exemplary embodiments of the micro light-emitting digital driving circuit, one or more source electrodes of the one or more subframe control switches are connected to a current mirror of the reference current supply module; one or more drain electrodes of the one or more subframe control switches are respectively connected to one or more drain electrodes of the one or more data transmission switches; and one or more source electrodes of the one or more data transmission switches are respectively connected to the one or more micro-LED pixels.

In some exemplary embodiments or any combination of exemplary embodiments of the micro light-emitting digital driving circuit, one or more gates of the one or more subframe control switches are respectively connected to one or more output ports on the subframe control unit; the time sequence control unit is electrically connected to the subframe control unit; and one or more gates of the one or more data transmission switches are respectively connected to one or more data output ports of the memory, and the external data input port is arranged on a second input end of the memory.

In some exemplary embodiments or any combination of exemplary embodiments of the micro light-emitting digital driving circuit, the reference current supply module comprises a current source and a current mirror. In some examples, the current source is electrically connected to a first end of the current mirror, and a second end of the current mirror is in current supply connection with the one or more micro-LED pixels.

Some exemplary embodiments of the present disclosure provide a digital driving method for some exemplary embodiments or any combination of exemplary embodiments of the micro light-emitting digital driving circuit, and the digital driving method includes: inputting the input image data frame by frame, through the external data input port and storing the input image data in the memory.

In some exemplary embodiments or any combination of exemplary embodiments of the digital driving method, the digital driving method includes: converting the bit data format of the input image data through the bit conversion unit, so that bits of the input image data are aligned with the one or more data transmission switches and the one or more subframe control switches; transmitting the bits of the input image data to the one or more micro-LED pixels through the one or more data transmission switches; and controlling a time sequence of the bits of the input image data through the time sequence control circuit module according to an image playback requirement.

In some exemplary embodiments or any combination of exemplary embodiments of the digital driving method, the number is 1, the bits of the input image data comprise a plurality of bits, and transmitting the bits of the input image data to the one or more micro-LED pixels through the one or more data transmission switches comprises: transmitting the plurality of bits of the input image data in the memory to the one or more micro-LED pixels in a position sequence or a random order of the plurality of bits through the one data transmission switch for display.

In some exemplary embodiments or any combination of exemplary embodiments of the digital driving method, controlling the time sequence of the bits of the input image data through the time sequence control circuit module according to the image playback requirement comprises: configuring the one subframe control switch according to weight of the plurality of bits of the input image data for driving and controlling of grayscale and brightness of an output display image.

In some exemplary embodiments or any combination of exemplary embodiments of the digital driving method, the number is greater than 1, the bits of the input image data comprise a plurality of bits, and transmitting the bits of the input image data to the one or more micro-LED pixels through the one or more data transmission switches comprises: transmitting the plurality of bits of the input image data in the memory to the one or more micro-LED pixels according to weight of the plurality of the bits of the input image data through the one or more data transmission switches sequentially for display.

In some exemplary embodiments or any combination of exemplary embodiments of the digital driving method, controlling the time sequence of the bits of the input image data through the time sequence control circuit module according to the image playback requirement comprises: configuring the one or more subframe control switches sequentially according to weight of the plurality of bits of the input image data for driving and controlling of grayscale and brightness of an output display image.

In some exemplary embodiments or any combination of exemplary embodiments of the digital driving method, the number is greater than 1, the bits of the input image data comprise a plurality of bits, and transmitting the bits of the input image data to the one or more micro-LED pixels through the one or more data transmission switches comprises: transmitting a first portion and a second portion sequentially of the plurality of bits of the input image data in the memory to the one or more micro-LED pixels through the one or more data transmission switches for display.

To solve the image display deficiency issues in the conventional light-emitting units with analog driving and controlling circuit that cannot be directly applied to the micro-LEDs, the present disclosure achieves the purpose of improving the light emitting parameters, such as brightness, and white balance by the design of the digital micro-LED pixel driving system to achieve image display on the micro-LED display screen.

In some exemplary embodiments, the present disclosure provides the following technical aspects:

In some aspects, a micro-LED pixel digital driving circuit comprises micro-LED pixels, a time sequence control circuit module, a data buffer conversion module and a reference current supply module, wherein the reference current supply module is in current supply connection with the micro-LED pixels.

In some embodiments, the time sequence control circuit module comprises a time sequence control unit, a subframe control unit and subframe control switches SF0, SF1, . . . , and SFn (n is a non-negative number). The data buffer conversion module comprises an external data input port, a memory and data transmission switches BO, B1, . . . , and Bn.

In some embodiments, the source electrodes of the subframe control switches SFO, SF1, . . . , and SFn are connected to a current mirror together, and the drain electrodes of the SFO, SF1, . . . , and SFn are respectively connected to the drain electrodes of the data transmission switches B0, B1, . . . , and Bn. The source electrodes of the data transmission switches B0, B1, . . . , and Bn are connected to the micro-LED pixel unit.

In some embodiments, the gates of the subframe control switches SF0, SF1, . . . , and SFn are respectively connected to a corresponding output port on the subframe control unit, and the time sequence control unit is electrically connected to the subframe control unit. The gates of the B0, B1, . . . , and Bn are respectively connected to a corresponding data output port of the memory, and the external data input port is arranged on the input end of the memory.

In some embodiments, the data transmission switches B0, B1, . . . , and Bn are configured for transmitting frame frequency image data signals to the micro-LED pixels for image display. The subframe control switches SF0, SF1, . . . , and SFn are configured to control the time sequence and/or brightness, etc. The number of the data transmission switches B0, B1, . . . , and Bn and subframe control switches SF0, SF1, . . . , and SFn may be set to a number of 1 or more. And the greater the number is, the larger the size of the driving chip is, and the higher the image data processing efficiency is. The number is selected according to the size of the display device.

In some embodiments, the data buffer conversion module comprises a bit conversion unit, and the bit conversion unit is arranged on the input end of the memory.

In some embodiments, the bit conversion unit is configured for converting the bit data format of the original image data.

In some embodiments, the number can be set to 1.

In some embodiments, the number of the subframe control switches is set to 1, and the subframe control switch is SF0. The number of the data transmission switches is set to 1, and the data transmission switch is B0.

In some embodiments, the number can be set to 4.

In some embodiments, the number of the subframe control switches is set to 4, and the subframe control switches are SF0, SF1, SF2 and SF3. The number of the data transmission switches is set to 4, and the data transmission switches are B0, B1, B2 and B3.

In some embodiments, the subframe control switches SF0, SF1, SF2 and SF3 are all high-voltage transistors, and the data transmission switches B0, B1, B2 and B3 are also selected as high-voltage transistors.

In some embodiments, the reference current supply module comprises a current source and a current mirror, wherein one end of the current source is electrically connected to one end of the current mirror, and the other end of the current mirror is in current supply connection with the micro-LED pixels.

In some aspects, the micro-LED pixel digital driving system comprises a display matrix, a time sequence control system and a frame buffer system, wherein the frame buffer system is in data connection with the display matrix, the time sequence control system is in control connection with the display matrix, and the time sequence control system is configured for controlling the frame buffer system to transmit data parameters of the image data in transmission to the display matrix.

In some aspects, a digital driving method for micro-LED pixels, comprises the following steps:
Step 1, the number of the subframe control switches and the data transmission switches are selected according to the space of the micro-LED display device. In some examples, n=1 or n=4 or n=8 or n=2^{k} (k is a non-negative integer).
Step 2, format conversion is carried out on the image data through the bit conversion unit, so that the bit positions are aligned with the subsequent data transmission switches B0, B1, . . . , and Bn and subframe control switches SF0, SF1, . . . , and SFn.
Step 3, through the data transmission switches B0, B1, . . . , and Bn, the data in the memory is transmitted to the display micro-LED pixels for display, and the driving and controlling are achieved by configuring the subframe control switches SF0, SF1, . . . , and SFn in the data transmission process.
Step 4, a time sequence control program is configured in the time sequence control unit and the subframe control unit according to the image playback requirement, and then driving and controlling are achieved by configuring the subframe control switches SF0, SF1, . . . , and SFn in Step 3.

In some aspects, a digital driving method for micro-LED pixels, comprises the following steps:
Step 1, the number of the subframe control switch and the data transmission switch is set to n, wherein n=1.
Step 2, the multi-bit data in the memory is transmitted to the display micro-LED pixel in the position sequence or a random order of the multi-bit data through the data transmission switch B0 for display, and the subframe control switch SF0 is configured according to the bit's position weight of a symbol/bit string in the data transmission process for driving and controlling of grayscale and/or brightness.
Step 3, a time sequence control program is configured in the time sequence control unit and the subframe control unit according to the image playback requirement, and then the switch SF0 is controlled by the subframe control switch SF0 in Step 2.

According to the above example, the driving method of the driving system is given, under the condition that the number of the subframe control switch and the data transmission switch respectively is 1.

In some aspects, a digital driving method for micro-LED pixels, comprises the following steps:
Step 1, the number of the subframe control switch and the data transmission switch is set to n, wherein n=4.
Step 2, the bits of the image data are converted into 4-bit data format by a bit conversion unit.
Step 3, the data in the memory is transmitted to the driving array circuit for displaying the micro-LED pixels through the data transmission switches B0, B1, B2 and B3, and driving and controlling are achieved by configuring the subframe control switches SF0, SF1, SF2 and SF3 according to the bit's weights in the data transmission process.
Step 4, a time sequence control program is configured in the time sequence control unit and the subframe control unit according to the image playback requirement, and then driving and controlling are achieved by configuring the subframe control switches SF0, SF1, SF2 and SF3 in Step 3.

According to the above example, the driving method of the driving system is given, under the condition that the number of the subframe control switch and the data transmission switch respectively is 4.

In summary, the digital micro-LED pixel driving system is configured to achieve better image characteristics for images displayed on the micro-LED display screen.

Note that the various embodiments described above may be combined with any other embodiments described herein. The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

So that the present disclosure may be understood in greater detail, a more particular description may be had by reference to the features of various embodiments, some of which are illustrated in the appended drawings. The appended drawings, however, merely illustrate pertinent features of the present disclosure and are therefore not to be considered limiting, for the description may admit to other effective features.

For convenience, “up” is used to mean away from the substrate or circuit board/plate of a light emitting structure, “down” means toward the substrate, and other directional terms such as top, bottom, above, below, under, beneath, etc. are interpreted accordingly.

FIG. 1 illustrates a schematic diagram showing an exemplary external layout of a micro-LED display driving system.

FIG. 2 illustrates a circuit structure diagram of an exemplary micro-LED pixel digital driving system.

FIG. 3 illustrates a circuit structure diagram of an exemplary micro-LED pixel digital driving system.

FIG. 4 illustrates a signal processing diagram of an exemplary micro-LED pixel digital driving system.

FIG. 5 illustrates a signal processing diagram of an exemplary controlled brightness of an exemplary pixel digital driving system.

FIG. 6 illustrates a circuit structure diagram of an exemplary micro-LED pixel digital driving system.

FIG. 7 illustrates a signal processing diagram of an exemplary micro-LED pixel digital driving system.

FIG. 8 illustrates a signal processing diagram of an exemplary controlled brightness of an exemplary pixel digital driving system.

FIG. 9 illustrates a signal processing diagram of an exemplary micro-LED pixel digital driving system.

FIG. 10 illustrates a signal processing diagram of an exemplary controlled brightness of an exemplary pixel digital driving system.

The FIGS. include the following identifications of parts: 01, display matrix; 02, time sequence control system; 03, frame buffer system; 1, micro-LED pixel unit; 2, time sequence control circuit module; 2-1, time sequence control unit; 2-2, subframe control unit; 3, data buffer conversion module; 3-1, bit conversion unit; 3-2, external data input port; 3-3, memory; 4, reference current supply module; 4-1, current source; 4-2, current mirror.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DETAILED DESCRIPTION

Numerous details are described herein in order to provide a thorough understanding of the example embodiments illustrated in the accompanying drawings. However, some embodiments may be practiced without many of the specific details, and the scope of the claims is only limited by those features and aspects specifically recited in the claims. Furthermore, well-known processes, components, and materials have not been described in exhaustive detail so as not to unnecessarily obscure pertinent aspects of the embodiments described herein.

The present application relates to the technical field of micro-LED display, and discloses a micro-LED pixel digital driving circuit and system and a driving method thereof.

In both analog and digital technologies, the information or data, such as any video or audio, is transformed into electric signals. Different from the analog circuits, wherein the information or data is converted into electric pulses of varying amplitude, the digital circuits translate the information or data into binary format (zero or one), wherein each bit of the data is representative of two distinct amplitudes.

In the present disclosure, the technical drawbacks of wavelength offset introduced by current change can be reduced to a maximum extent compared with a traditional analog current driving mode. The micro-LED pixel digital driving circuit comprises micro-LED pixels, a time sequence control circuit module, a data buffer conversion module, and a reference current supply module. The reference current supply module is in current supply connection with the micro-LED pixels; the time sequence control circuit module comprises a time sequence control unit, a subframe control unit and subframe control switches SF0, SF1, . . . , and SFn (n is a non-negative integer). The data buffer conversion module comprises an external data input port, a memory, and data transmission switches B0, B1, . . . , and Bn. The gates of data transmission switches B0, B1, . . . , and Bn are connected to the data output ports of the memory respectively. The external data input port is arranged on the input end of the memory. The digital micro-LED pixel driving system disclosed herein drives the micro-LED pixels to display images on a display screen.

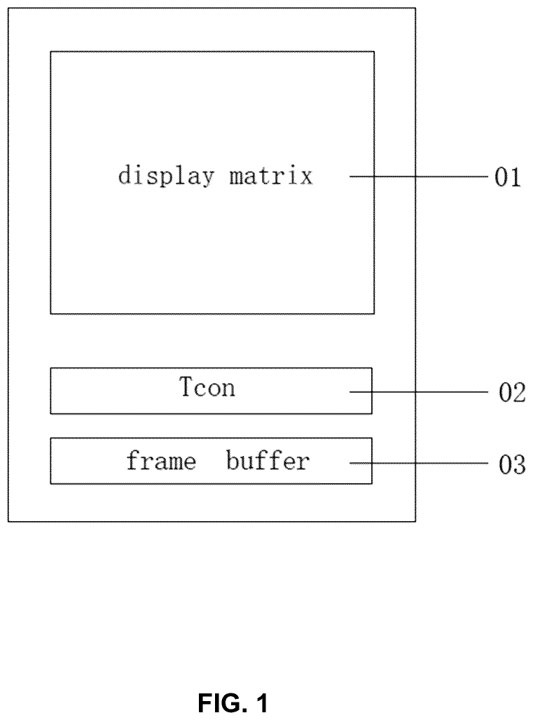

FIG. 1 illustrates a schematic diagram showing an exemplary external layout of a micro-LED display driving system.

In one or more implementations, a micro-LED pixel digital driving system, as shown in FIG. 1, comprises a display matrix 01, a time sequence control system 02 and a frame buffer system 03. In the field of Micro-LED display, the display matrix 01 refers to an array composed of a plurality of Micro-LED pixels (such as 2040*1080), the time sequence control system 02 is an integrated control chip, and the frame buffer system 03 is a memory. In some examples, the frame buffer system 03 is used for accessing and storing external image data, and the frame buffer system 03 is in connection with the display matrix 01 for data transmission, so that the data stored in the frame buffer system 03 can be displayed by the display matrix 01. In practice, the image in the display matrix 01 needs to meet various color requirements. Therefore, it is necessary to control the time sequence of data transmission from the frame buffer system 03 to the display matrix 01 or the display brightness and grayscale of the display matrix 01. In some examples, the time sequence control system 02 is electrically connected between the display matrix 01 and the frame buffer system 03, so as to drive and load the data in the frame buffer system 03 through the time sequence control system 02.

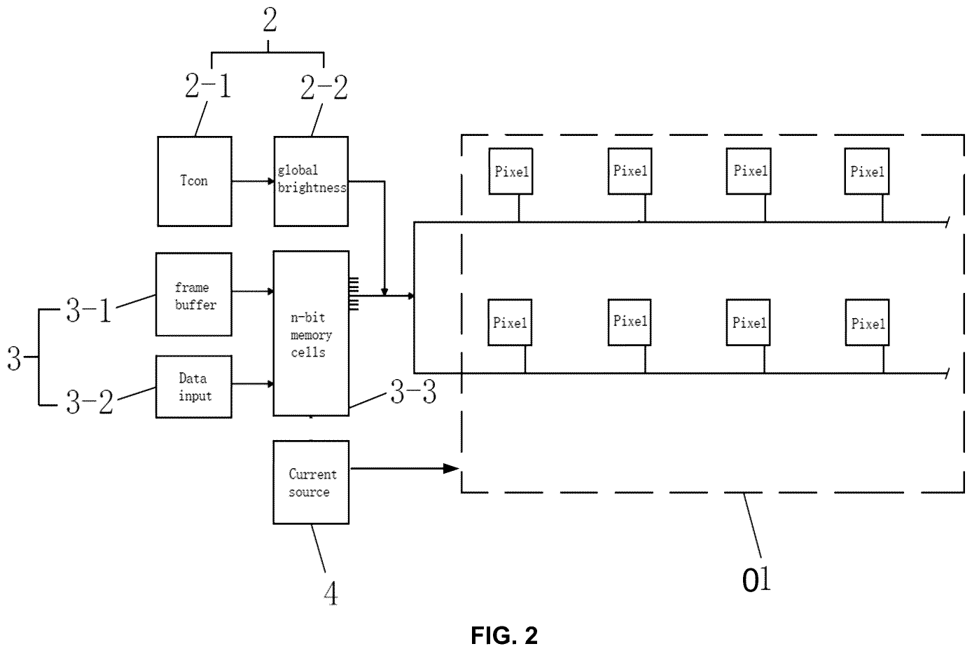

FIG. 2 illustrates a circuit structure diagram of an exemplary micro-LED pixel digital driving system.

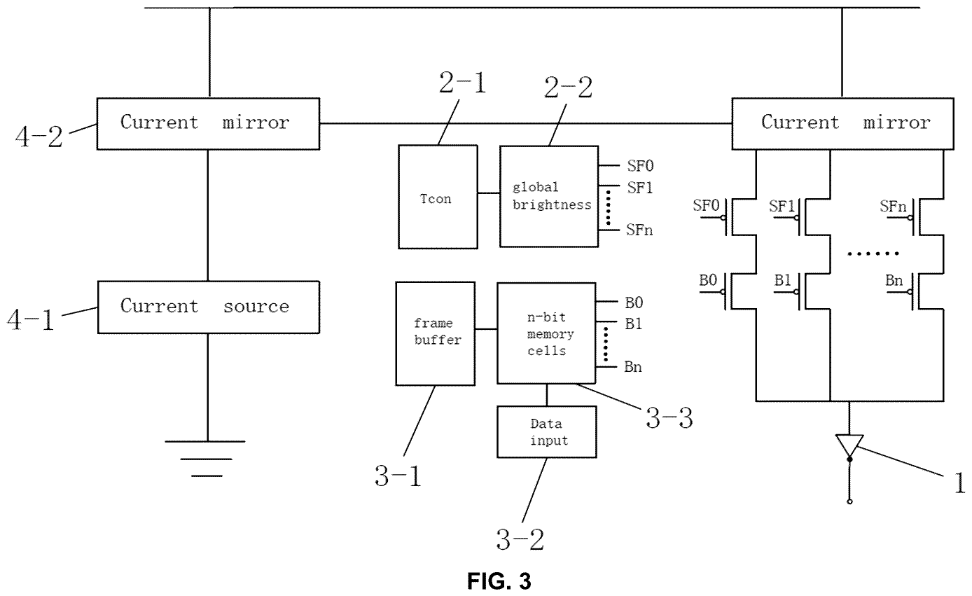

FIG. 3 illustrates a circuit structure diagram of an exemplary micro-LED pixel digital driving system (e.g., the micro-LED pixel digital driving system of FIG. 2).

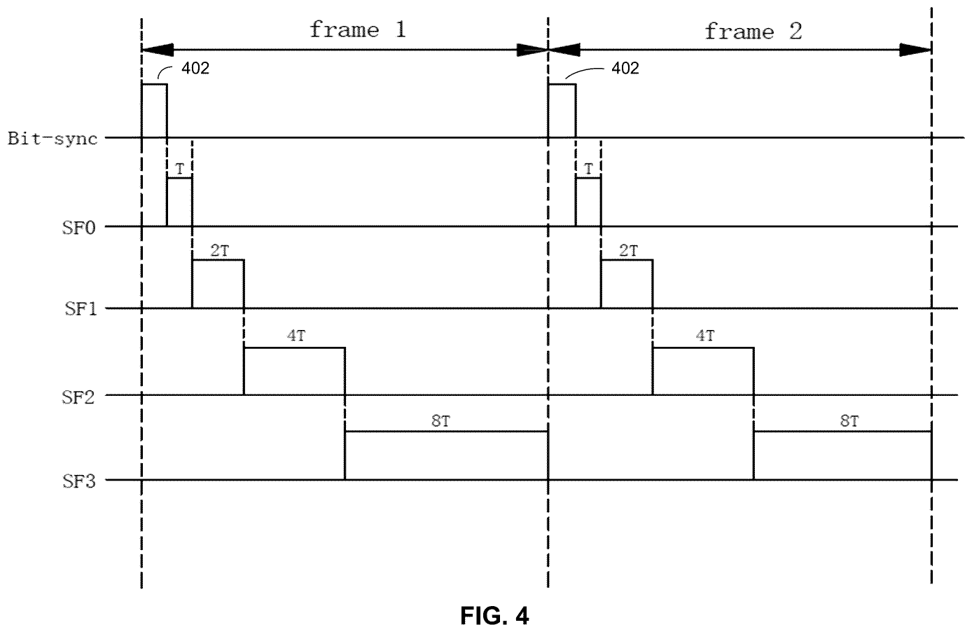

FIG. 4 illustrates a signal processing diagram of an exemplary micro-LED pixel digital driving system (e.g., the micro-LED pixel digital driving system of FIG. 2 or FIG. 3).

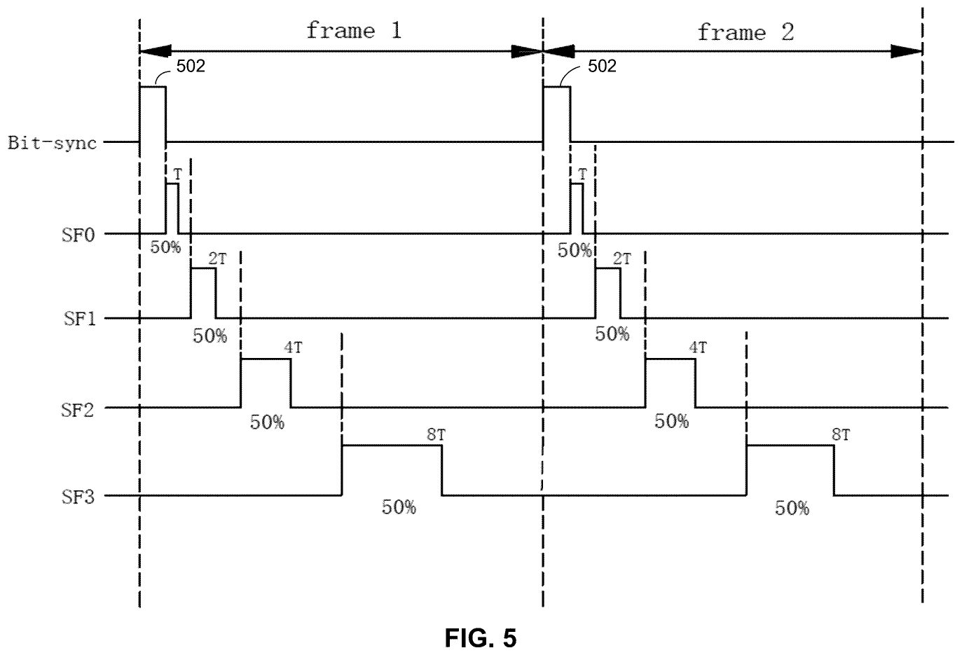

FIG. 5 illustrates a signal processing diagram of an exemplary controlled brightness of an exemplary pixel digital driving system (e.g., the micro-LED pixel digital driving system of FIG. 2 or FIG. 3).

In one or more implementations, a micro-LED pixel digital driving circuit, as illustrated in FIGS. 2-5, comprises the micro-LED pixel unit 1, a time sequence control circuit module 2, a data buffer conversion module 3, and a reference current supply module 4. In some examples, the reference current supply module 4 is used for supplying constant current to the micro-LED pixel unit 1. The data buffer conversion module 3 performs format conversion on the external input data and stores the external input data. The data buffer conversion module 3 is electrically connected to the micro-LED pixel unit 1, so that the data stored in the data buffer conversion module 3 can be displayed through the micro-LED pixel unit 1. The time sequence control circuit module 2 is electrically connected between the data buffer conversion module 3 and the micro-LED pixel unit 1 and is used for driving and controlling the display sequence and other display parameters of the micro-LED pixel unit 1. In FIG. 2, the display matrix 01 includes one or more of the micro-LED pixel units 1.

In some examples, the micro-LED pixel unit 1 is a single pixel in the display matrix 01. In some examples, as shown in FIG. 3, the reference current supply module 4 comprises a current source 4-1 and a current mirror 4-2, wherein one end of the current source 4-1 and one end of the current mirror 4-2 are electrically connected, and the other end of the current mirror 4-2 is used for supplying current to the micro-LED pixel unit 1. In some examples, the current mirror 4-2 duplicates the same current from the current source and supplies a constant current to each of the micro-LED pixel unit 1.

In some examples, the time sequence control circuit module 2 and the circuit structure of the data buffer conversion module 3 are arranged as follows: the components in the time sequence control circuit module 2 comprise a time sequence control unit 2-1, a subframe control unit 2-2 and subframe control switches SF0, SF1, . . . , and SFn, wherein the number of the subframe control switches may be N (N is positive integer). In some examples, subframe control unit 2-2 controls global brightness of each of the pixels of the display matrix 01, and each of the pixels of the display matrix 01 is connected to the same set of subframe control switches SF0, SF1, . . . , and SFn for brightness control. Taking the number of the subframe control switches being 4 as an example, the subframe control switches comprise SF0, SF1, SF2 and SF3. The components in the data buffer conversion module 3 comprise a bit conversion unit 3-1, an external data input port 3-2, a memory 3-3, and data transmission switches B0, B1, . . . , and Bn. The number of the data transmission switches may be N. In this example, the number of the data transmission switches is set to 4 as an example, that is, the data transmission switches comprise B0, B1, B2, and B3. In some examples, the value of N is selected according to the number of bits of the image data or a fraction of the number of bits of the image data (for example, ½, ¼, ⅛, 1/16, 1/32, etc.) In some examples, high-voltage transistors are selected for SF0, SF1, SF2 and SF3 and B0, B1, B2 and B3. In some examples, the high-voltage transistors refer to low-leakage transistors. In some examples, a low leakage transistor has a very low off-leakage current. In some examples, the high-voltage transistors handle input/output signals which require higher supply voltage (e.g., 1.8 V, 2.5 V, or 1.8 V to 3.3 V, or other ranges depending on the circuit) than other logic devices, such as logic Core devices within the same integrated circuit chip/board. The source electrodes of SF0, SF1, SF2 and SF3 are connected to the current mirrors 4-2, the drain electrodes of SF0, SF1, SF2 and SF3 are respectively connected to the drain electrodes of B0, B1, B2 and B3, and the source electrodes of B0, B1, B2 and B3 are connected to the micro-LED pixel unit 1. In some examples, the subframe control switches and the data transmission switches are transistors, such as field-effect transistor (FET), metal-oxide-semiconductor field-effect transistor (MOSFET), bipolar junction transistor (BJT).

In some examples, the gates of SF0, SF1, SF2 and SF3 are respectively connected to corresponding output ports on the subframe control unit 2-2. The time sequence control unit 2-1 is electrically connected to the subframe control unit 2-2. The gates of B0, B1, B2 and B3 are respectively connected to corresponding data output ports of the memory 3-3. The external data input port 3-2 is arranged on an input end of the memory 3-3, and the bit conversion unit 3-1 is arranged on an input end of the memory 3-3.

In some examples, each of the circuit structures of the time sequence control unit 2-1, the subframe control unit 2-2, the bit conversion unit 3-1, the external data input port 3-2, and the memory 3-3 may be understood and implemented by a person of ordinary skills in the art. For examples, the time sequence control unit 2-1, the subframe control unit 2-2, the bit conversion unit 3-1, the external data input port 3-2, and the memory 3-3 are implemented by application-specific integrated circuits (ASICs) using p-channel metal-oxide-semiconductor (PMOS) or n-channel metal-oxide semiconductor (NMOS), or other types of transistors. In some examples, the time sequence control unit 2-1, the subframe control unit 2-2, the bit conversion unit 3-1, the external data input port 3-2, and the memory 3-3 may be implemented by other integrated circuit chip or board including field-programmable gate array (FPGA). The memory 3-3 may be implemented by static random-access memory (SRAM), or dynamic random-access memory (DRAM).

In some examples, according to the above-described micro-LED pixel digital driving circuit structure of FIGS. 2-5, a micro-LED pixel digital driving method in one or more implementations comprises the following steps.

Step 1. In some examples, frame by frame, the image data is input through the external data input port 3-2 and stored in the memory 3-3. The data output port of the memory 3-3 is connected to the data transmission switches B0, B1, B2 and B3, so as to deliver the data to the micro-LED pixel unit 1 for display. A constant current is provided through the current mirror 4-2.

In some examples, when the input of the external image data is 8 bits, and if the subsequent subframe control switches are SF0, SF1, SF2, and SF3, a lower 4 bits of the 8-bit signal need to be transmitted and displayed, and then the higher 4 bits of the 8 bit signal are transmitted and displayed. In some other examples, if the subsequent subframe control switches are SF0-SF7, all 8 bits are transmitted and displayed with the subsequent SF0, SF1, SF2, SF3, SF4, SF5, SF6, SF7 and B0, B1, B2, B3, B4, B5, B6, B7.

Step 2. In some examples, a time sequence control circuit module 2 is arranged on a current supply line from the current mirror 4-2 to the micro-LED pixel unit 1. The time sequence control circuit module 2 includes subframe control switches SF0, SF1, SF2 and SF3, and sends a driving and controlling signal to the subframe control switches SF0, SF1, SF2 and SF3 through the subframe control unit 2-2. The time sequence control circuit module 2 controls the on and off of the subframe control switches SF0, SF1, SF2 and SF3, and may also control parameters such as the ratio of the conduction time and the disconnection time of SF0, SF1, SF2, and SF3. Therefore, the display parameters such as the brightness, and/or grayscale of the micro-LED pixel unit 1 may be controlled.

FIG. 4 illustrates an example of driving/controlling an n-bit grayscale (for example, n=4) at full brightness by the exemplary micro-LED pixel digital driving system illustrated in FIGS. 2-3. In some examples, with the bit-sync pulse 402, frame by frame sequentially (for example, frame 1 is followed by frame 2, etc.), the image data is input through the external data input port 3-2 and stored in the memory 3-3. In some examples, the memory 3-3 includes an n-bit memory cell for each single pixel display unit. For example, for each frame, a 4-bit image data is input though the data input port 3-2 or the frame buffer 3-1 and stored in the n-bit memory cell 3-3 (n=4 for 4-bit). In some examples, all 4 bits of data are stored in the 4-bit memory cell for the single pixel display unit after the trigger of the bit-sync pulse 402. The time sequence control circuit module 2 includes the subframe control switches SF0, SF1, SF2 and SF3, and sends a driving and controlling signal to the subframe control switches SF0, SF1, SF2 and SF3 through the subframe control unit 2-2. The time sequence control circuit module 2 sequentially controls the conduction time and the disconnection time of the subframe control switches SF0, SF1, SF2, and SF3 to display the 4-bit grayscale data from the 4-bit memory cell at full brightness. In some examples, at full brightness, the conduction time of the respective subframe control switch is equal to the duty cycle of the respective bit data as shown in FIG. 4. In some examples, the duty cycle duration is determined according to a bit's weight. In some examples, the bit data (for example, with a duty cycle T) for the subframe control switch SF0 is processed first, followed by the bit data (for example, with a duty cycle 2T) for the subframe control switch SF1, then the bit data (for example, with a duty cycle 4T) for the subframe control switch SF2, and lastly the bit data (for example, with a duty cycle 8T) for the subframe control switch SF3. In some examples, the bit data for each of the subframe control switches SF0, SF1, SF2 and SF3 may be processed in any other order. In some examples, the bit data for the frame is displayed sequentially.

FIG. 5 illustrates an example of driving/controlling an n-bit grayscale (for example, n=4) at controlled brightness by the exemplary micro-LED pixel digital driving system illustrated in FIGS. 2-3. In some examples, with the bit-sync pulse 502, frame by frame sequentially (for example, frame 1 is followed by frame 2, etc.), the image data is input through the external data input port 3-2 and stored in the memory 3-3. In some examples, the memory 3-3 includes an n-bit memory cell for each single pixel display unit. For example, for each frame, a 4-bit image data is input though the data input port 3-2 or the frame buffer 3-1 and stored in the n-bit memory cell 3-3 (n=4 for 4-bit). In some examples, all 4 bits of data are stored in the 4-bit memory cell for the single pixel display unit after the trigger of the bit-sync pulse 502. The time sequence control circuit module 2 includes the subframe control switches SF0, SF1, SF2 and SF3, and sends a driving and controlling signal to the subframe control switches SF0, SF1, SF2 and SF3 through the subframe control unit 2-2. The time sequence control circuit module 2 sequentially controls the conduction time and the disconnection time of the subframe control switches SF0, SF1, SF2, and SF3 to display the 4-bit grayscale data from the 4-bit memory cell at a controlled brightness. In some examples, at controlled brightness, for example 50% of the full brightness, the conduction time of the respective subframe control switch is equal to half of the duty cycle of the respective bit data as shown in FIG. 5. In some examples, according to the brightness setting, the ratio of the conduction time of a respective subframe control switch to the duty cycle of the respective bit data may be adjusted from 0% to 100%. In some examples, the ratio of the conduction time of a respective subframe control switch to the duty cycle of the respective bit data may be the same for all the subframe control switches (for example, SF0, SF1, SF2, and SF3) within a frame or several frames. In some examples, the bit data (for example, with a duty cycle T) for the subframe control switch SF0 is processed first, followed by the bit data (for example, with a duty cycle 2T) for the subframe control switch SF1, then the bit data (for example, with a duty cycle 4T) for the subframe control switch SF2, and lastly the bit data (for example, with a duty cycle 8T) for the subframe control switch SF3. In some examples, the bit data for each of the subframe control switches SF0, SF1, SF2 and SF3 may be processed in any other order. In some examples, the bit data for the frame is displayed sequentially.

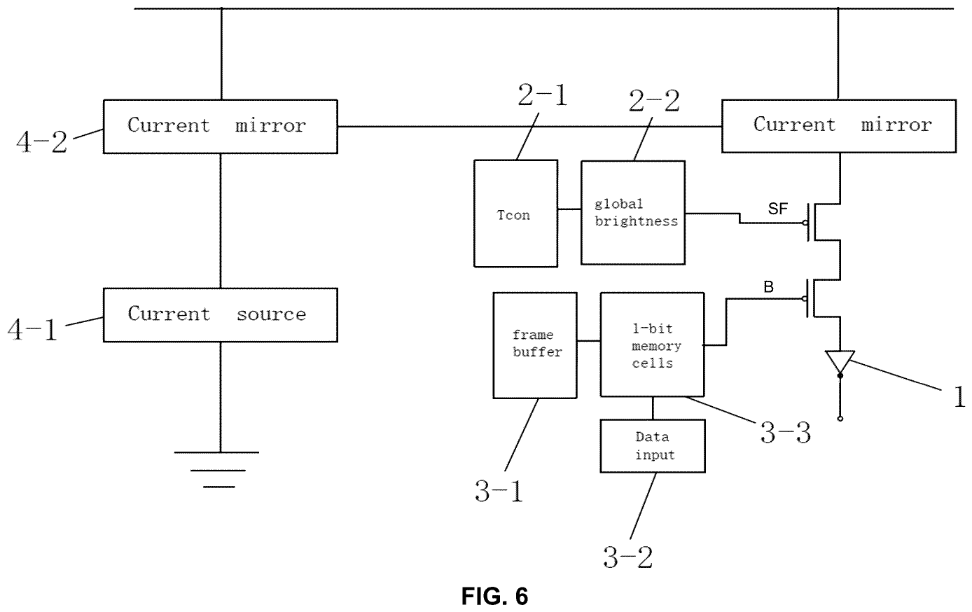

FIG. 6 illustrates a circuit structure diagram of an exemplary micro-LED pixel digital driving system.

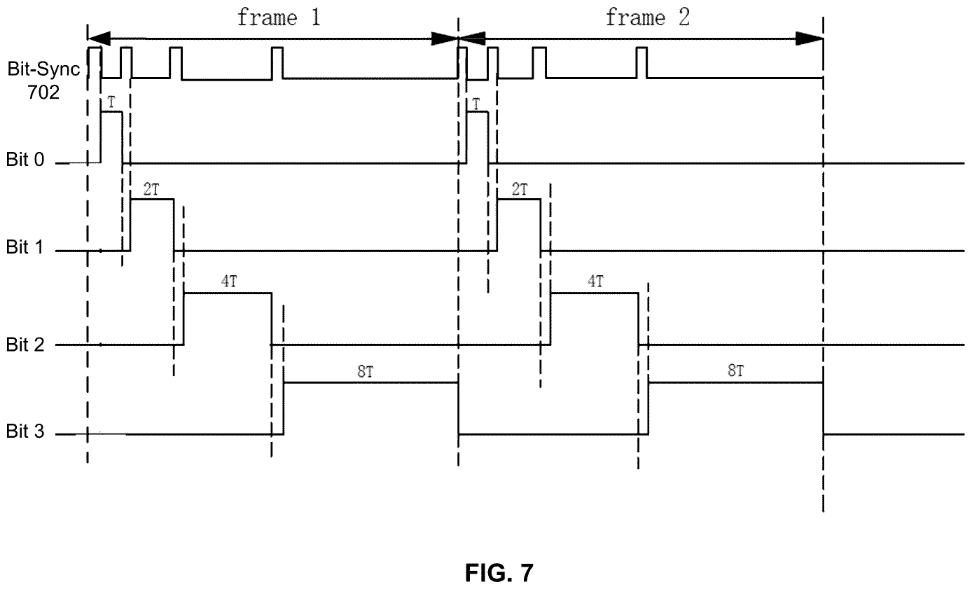

FIG. 7 illustrates a signal processing diagram of an exemplary micro-LED pixel digital driving system (e.g., the micro-LED pixel digital driving system of FIG. 6).

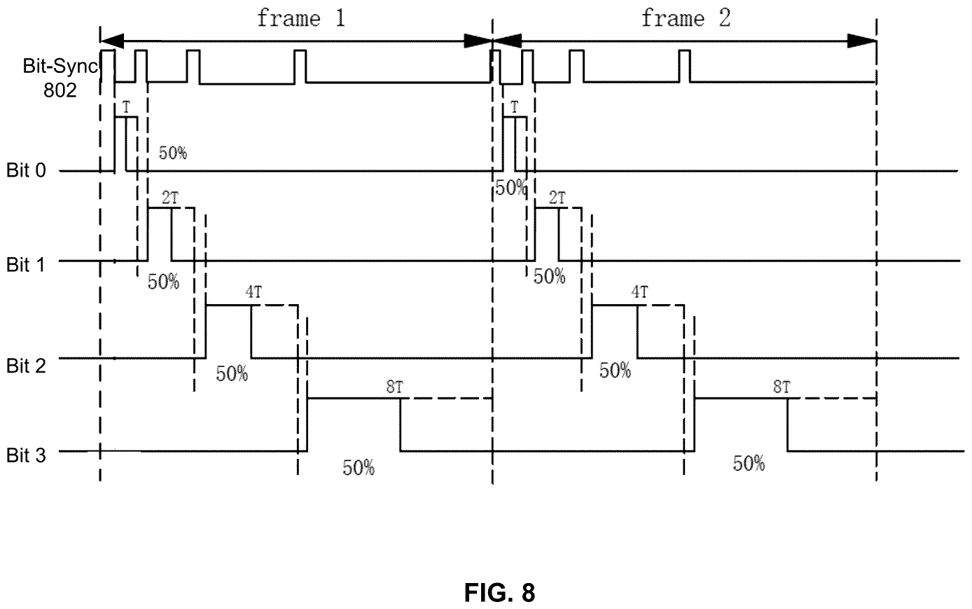

FIG. 8 illustrates a signal processing diagram of an exemplary controlled brightness of an exemplary pixel digital driving system (e.g., the micro-LED pixel digital driving system of FIG. 6).

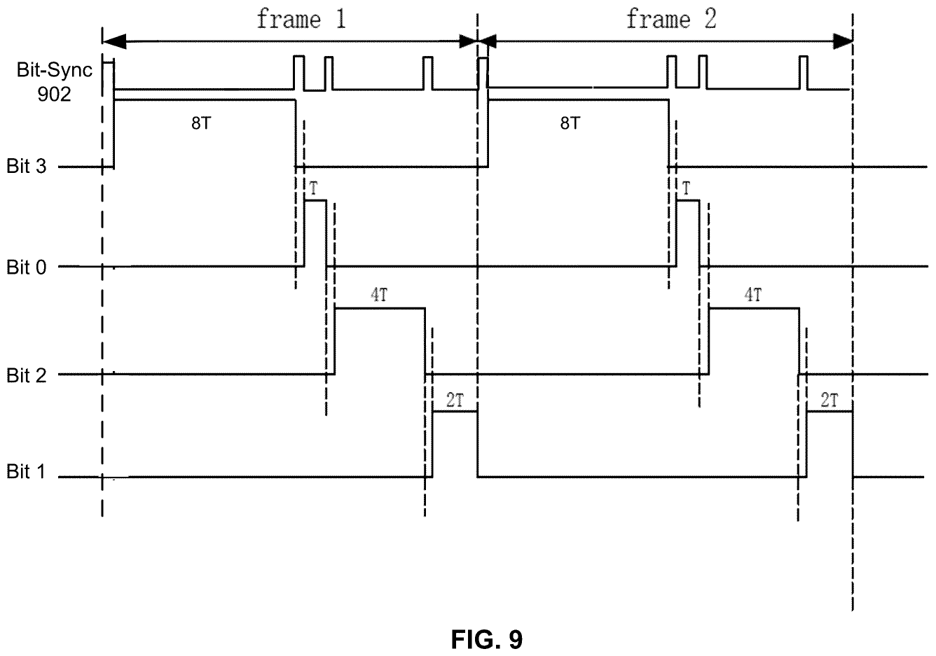

FIG. 9 illustrates a signal processing diagram of an exemplary micro-LED pixel digital driving system (e.g., the micro-LED pixel digital driving system of FIG. 6).

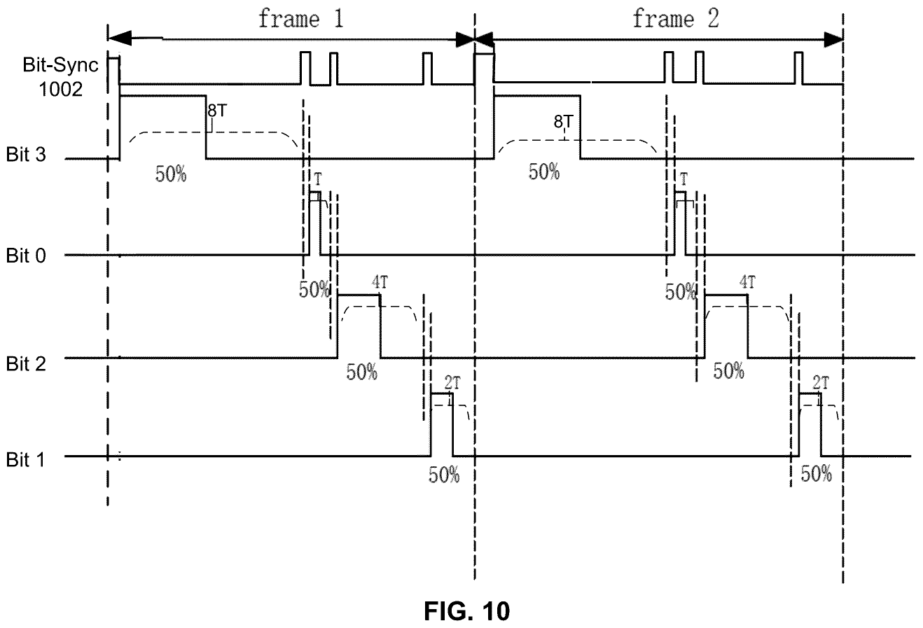

FIG. 10 illustrates a signal processing diagram of an exemplary controlled brightness of an exemplary pixel digital driving system (e.g., the micro-LED pixel digital driving system of FIG. 6).

In one or more implementations, a micro-LED pixel digital driving circuit, as illustrated in FIGS. 6-10, comprises the micro-LED pixel unit 1, a time sequence control circuit module 2, a data buffer conversion module 3 and a reference current supply module 4. In some examples, the reference current supply module 4 is used for supplying constant current to the micro-LED pixel unit 1. The data buffer conversion module 3 performs format conversion on the external input data and stores the external input data. The data buffer conversion module 3 is electrically connected to the micro-LED pixel unit 1, so that the data stored in the data buffer conversion module 3 can be displayed through the micro-LED pixel unit 1. The time sequence control circuit module 2 is electrically connected between the data buffer conversion module 3 and the micro-LED pixel unit 1, and is used for driving and controlling the display sequence and other display parameters of the micro-LED pixel unit 1.

In some examples, the micro-LED pixel unit 1 is a single pixel in the display matrix 01. In some examples, as shown in FIG. 6, the reference current supply module 4 comprises a current source 4-1 and a current mirror 4-2, wherein one end of the current source 4-1 and one end of the current mirror 4-2 are electrically connected, and the other end of the current mirror 4-2 is used for providing power and/or a constant current to the micro-LED pixel unit 1. In some examples, the current mirror 4-2 supplies a constant current to each of the micro-LED pixel unit 1.

In some examples, the time sequence control circuit module 2 and the circuit structure of the data buffer conversion module 3 are provided as follows: the components in the time sequence control circuit module 2 comprise a time sequence control unit 2-1, a subframe control unit 2-2 and a subframe control switch SF. The components in the data buffer conversion module 3 comprise a bit conversion unit 3-1, an external data input port 3-2, a memory 3-3, and a data transmission switch B. In some examples, a connection circuit structure of the subframe control switch SF and the data transmission switch B is separately provided. In some examples, the structure shown in FIG. 6 is mainly applied to a pixel driving design with an extremely small size in the field (e.g., under 50 um, under 20 um, under 10 um, or preferably under 4 um, for example 2-20 um).

In some examples, a high-voltage transistor is selected for SF, and a high-voltage transistor is selected B. The source electrode of SF is connected to a current mirror 4-2, the drain electrode of SF is connected to the drain electrode of B, and the source electrode of B is connected to the micro-LED pixel unit 1.

In some examples, the gate of the SF is connected to a corresponding output port on the subframe control unit 2-2. The time sequence control unit 2-1 is electrically connected to the subframe control unit 2-2. The gate of B is connected to the data output port of the memory 3-3. The external data input port 3-2 is arranged on an input end of the memory 3-3, and the bit conversion unit 3-1 is arranged on an input end of the memory 3-3.

In some examples, each of the circuit structures of the time sequence control unit 2-1, the subframe control unit 2-2, the bit conversion unit 3-1, the external data input port 3-2, and the memory 3-3 may be understood and implemented by a person of ordinary skills in the art.

In some examples, according to the above-described micro-LED pixel digital driving circuit structure of FIGS. 6-10, a micro-LED pixel digital driving method in one or more implementations comprises the following steps.

Step 1. In some examples, frame by frame, the image data is input through an external data input port 3-2 and stored in the memory 3-3. The data is transmitted to the pixels one by one for display, and a constant current is provided through the current mirror 4-2.

In some examples, the format of the external image data is, for example, 4 bits or other N bits, but only one data transmission switch B is provided, and at this time, data transmission is performed in a sequential transmission manner, but the 4-bits display sequence may be randomly ordered, not limited to Bit0-Bit1-Bit2-Bit3, and the display sequence of Bit2-Bit3-Bit0-Bit1 can also be performed. However, the bits in the transmission mode are carried out one by one.

Step 2. In some examples, a time sequence control circuit module 2 is arranged on a current supply line from the current mirror 4-2 to the micro-LED pixel unit 1. The time sequence control circuit module 2 includes subframe control switch SF, and sends a driving and controlling signal to the subframe control switch SF through the subframe control unit 2-2. The time sequence control circuit module 2 controls the on and off of the subframe control switch SF, and may also control parameters such as the ratio of the conduction time and the disconnection time of the SF. Therefore, the display parameters such as the lighting brightness of the micro-LED pixel unit 1 may be controlled.

FIG. 7 illustrates an example of driving/controlling an n-bit grayscale (for example, n=4) at full brightness by the exemplary micro-LED pixel digital driving system illustrated in FIG. 6. In some examples, with the bit-sync pulses 702, frame by frame sequentially (for example, frame 1 is followed by frame 2, etc.), and bit by bit sequentially within each frame, the image data is input through the external data input port 3-2 and stored in the memory 3-3 followed by each bit-sync pulse 702. In some examples, especially when the single pixel display unit has a relatively small space or constrained area on an integrated circuit, the memory 3-3 includes a 1-bit memory cell for each single pixel display unit. For example, for each frame, a 4-bit image data is input sequentially though the data input port 3-2 or the frame buffer 3-1 and stored in the 1-bit memory cell 3-3 after each bit-sync pulse 702. The time sequence control circuit module 2 includes the subframe control switch SF. The time sequence control circuit module 2 sends a driving and controlling signal to the subframe control switch SF through the subframe control unit 2-2. In some examples, the time sequence control circuit module 2 controls the conduction time of the subframe control switch SF to display the 4-bit grayscale data sequentially from the 1-bit memory cell at full brightness. In some examples, at full brightness, the conduction time of the respective subframe control switch is equal to the duty cycle of the respective bit data as shown in FIG. 7. In some examples, the duty cycle duration is determined according to a bit's weight. In some examples, the bit data (for example, with a duty cycle T) for Bit 0 is processed first, followed by the bit data (for example, with a duty cycle 2T) for Bit 1, then the bit data (for example, with a duty cycle 4T) for Bit 2, and lastly the bit data (for example, with a duty cycle 8T) for Bit 3. In some examples, the bit data for each of Bit 0, Bit 1, Bit 2, and Bit 3 may be processed in any other order, such as sequentially in the order of Bit 3, Bit 0, Bit 2 and Bit 1 as shown in FIG. 9 with bit-sync pulses 902. In some examples, the bit data for the frame is displayed sequentially. In some examples, the bit-sync pulses may trigger the bit display according to the bit duty cycle.

FIG. 8 illustrates an example of driving/controlling an n-bit grayscale (for example, n=4) at controlled brightness by the exemplary micro-LED pixel digital driving system illustrated in FIG. 6. In some examples, with the bit-sync pulses 802, frame by frame sequentially (for example, frame 1 is followed by frame 2, etc.), and bit by bit sequentially within each frame, the image data is input through the external data input port 3-2 and stored in the memory 3-3 followed by each bit-sync pulse 802. In some examples, especially when the single pixel display unit has a relatively small space or constrained area on an integrated circuit, the memory 3-3 includes a 1-bit memory cell for each single pixel display unit. For example, for each frame, a 4-bit image data is input sequentially though the data input port 3-2 or the frame buffer 3-1 and stored in the 1-bit memory cell 3-3 after each bit-sync pulse 802. The time sequence control circuit module 2 includes the subframe control switch SF.

The time sequence control circuit module 2 sends a driving and controlling signal to the subframe control switch SF through the subframe control unit 2-2. The time sequence control circuit module 2 sequentially controls the conduction time and the disconnection time of the subframe control switch SF to display the 4-bit grayscale data from the 1-bit memory cell at a controlled brightness. In some examples, at controlled brightness, for example 50% of the full brightness, the conduction time of the respective subframe control switch is equal to half of the duty cycle of the respective bit data as shown in FIG. 8. In some examples, according to the brightness setting, the ratio of the conduction time of a respective subframe control switch SF to the duty cycle of the respective bit data may be adjusted from 0% to 100%. In some examples, the ratio of the conduction time of a respective subframe control switch to the duty cycle of the respective bit data may be the same for all the bits within a frame or several frames. In some examples, the bit data (for example, with a duty cycle T) for Bit 0 is processed first, followed by the bit data (for example, with a duty cycle 2T) for Bit 1, then the bit data (for example, with a duty cycle 4T) for Bit 2, and lastly the bit data (for example, with a duty cycle 8T) for Bit 3. In some examples, the bit data for each of Bit 0, Bit 1, Bit 2, and Bit 3 may be processed in any other order, such as sequentially in the order of Bit 3, Bit 0, Bit 2 and Bit 1 as shown in FIG. 10 with bit-sync pulses 1002. In some examples, the bit data for the frame is displayed sequentially. In some examples, the bit-sync pulses may trigger the bit display according to the bit duty cycle.

It is understood by those skilled in the art that, the micro-LED pixel digital driving system is not limited by the structure mentioned above, and may include more or less components than those as illustrated, or some components may be combined, or a different component may be utilized.

The above descriptions are merely embodiments of the present disclosure, and the present disclosure is not limited thereto. A modifications, equivalent substitutions and improvements made without departing from the conception and principle of the present disclosure shall fall within the protection scope of the present disclosure.

Further embodiments also include various subsets of the above embodiments including embodiments as shown in FIGS. 1-10 combined or otherwise re-arranged in various other embodiments.

Although the detailed description contains many specifics, these should not be construed as limiting the scope of the disclosure but merely as illustrating different examples and aspects of the disclosure. It should be appreciated that the scope of the disclosure includes other embodiments not discussed in detail above. For example, the approaches described above may be applied to the integration of functional devices other than LEDs and OLEDs with control circuitry other than pixel drivers. Examples of non-LED devices include vertical cavity surface emitting lasers (VCSEL), photodetectors, micro-electro-mechanical system (MEMS), silicon photonic devices, power electronic devices, and distributed feedback lasers (DFB). Examples of other control circuitry include current drivers, voltage drivers, trans-impedance amplifiers, and logic circuits.

The preceding description of the disclosed embodiments is provided to enable any person skilled in the art to make or use the embodiments described herein and variations thereof. Various modifications to these embodiments will be readily apparent to those skilled in the art, and the generic principles defined herein may be applied to other embodiments without departing from the spirit or scope of the subject matter disclosed herein. Thus, the present disclosure is not intended to be limited to the embodiments shown herein but is to be accorded the widest scope consistent with the following claims and the principles and novel features disclosed herein.

Features of the present disclosure may be implemented in, using, or with the assistance of a computer program product, such as a storage medium (media) or computer readable storage medium (media) having instructions stored thereon/in which may be used to program a processing system to perform any of the features presented herein. The storage medium may include, but is not limited to, high-speed random access memory, such as DRAM, SRAM, DDR RAM or other random access solid state memory devices, and may include non-volatile memory, such as one or more magnetic disk storage devices, optical disk storage devices, flash memory devices, or other non-volatile solid state storage devices. Memory optionally includes one or more storage devices remotely located from the CPU(s). Memory or alternatively the non-volatile memory device(s) within the memory, comprises a non-transitory computer readable storage medium.

Stored on any machine readable medium (media), features of the present disclosure may be incorporated in software and/or firmware for controlling the hardware of a processing system, and for enabling a processing system to interact with other mechanisms utilizing the results of the present disclosure. Such software or firmware may include, but is not limited to, application code, device drivers, operating systems, and execution environments/containers.

It will be understood that, although the terms “first,” “second,” etc. may be used herein to describe various elements or steps, these elements or steps should not be limited by these terms. These terms are only used to distinguish one element or step from another.

The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art to best utilize the disclosure and the various embodiments.

What is claimed is:

1. A micro light-emitting digital driving circuit, comprising:
one or more micro-light-emitting-diode (micro-LED) pixels;
a time sequence control circuit module;
a data buffer conversion module; and
a reference current supply module;
wherein:
the time sequence control circuit module comprises a time sequence control unit, a subframe control unit and one or more subframe control switches,
the data buffer conversion module comprises an external data input port, a memory and one or more data transmission switches, and
the reference current supply module is configured to supply constant current to the one or more micro-LED pixels.

2. The micro light-emitting digital driving circuit according to claim 1, wherein the data buffer conversion module further comprises a bit conversion unit arranged on a first input end of the memory, and configured for converting a bit data format of an input image data.

3. The micro light-emitting digital driving circuit according to claim 2, wherein a number of the one or more subframe control switches and a number of the one or more data transmission switches are the same, and the number is configured to be n=2^{k}, wherein k is a non-negative integer.

4. The micro light-emitting digital driving circuit according to claim 2, wherein a number of the one or more subframe control switches and a number of the one or more data transmission switches are the same, and the number is selected according to a number of bits of the input image data.

5. The micro light-emitting digital driving circuit according to claim 1, wherein each of the one or more subframe control switches comprises a source electrode, a drain electrode, and a gate, and each of the one or more data transmission switches comprises a source electrode, a drain electrode, and a gate.

6. The micro light-emitting digital driving circuit according to claim 5, wherein:
one or more source electrodes of the one or more subframe control switches are connected to a current mirror of the reference current supply module;
one or more drain electrodes of the one or more subframe control switches are respectively connected to one or more drain electrodes of the one or more data transmission switches; and
one or more source electrodes of the one or more data transmission switches are respectively connected to the one or more micro-LED pixels.

7. The micro light-emitting digital driving circuit according to claim 5, wherein:
one or more gates of the one or more subframe control switches are respectively connected to one or more output ports on the subframe control unit;
the time sequence control unit is electrically connected to the subframe control unit; and
one or more gates of the one or more data transmission switches are respectively connected to one or more data output ports of the memory, and the external data input port is arranged on a second input end of the memory.

8. The micro light-emitting digital driving circuit according to claim 1, wherein:
the reference current supply module comprises a current source and a current mirror, wherein the current source is electrically connected to a first end of the current mirror, and a second end of the current mirror is in current supply connection with the one or more micro-LED pixels.

9-15. (canceled)

16. The micro light-emitting digital driving circuit according to claim 8, wherein a current supplied by the current mirror to the one or more micro-LED pixels is the same as a current supplied by the current source.

17. The micro light-emitting digital driving circuit according to claim 1, wherein the subframe control unit is configured to control global brightness of each of the one or more micro-LED pixels, and each of the one or more micro-LED pixels is connected to a same set of subframe control switches for brightness control.

18. The micro light-emitting digital driving circuit according to claim 1, wherein the one or more subframe control switches are high-voltage transistors.

19. The micro light-emitting digital driving circuit according to claim 1, wherein the data transmission switches are high-voltage transistors.

20. A digital driving method, comprising:
providing a micro light-emitting digital driving circuit, the micro light-emitting digital driving circuit comprising a time sequence control circuit module and a data buffer conversion module, wherein:
the time sequence control circuit module comprises a time sequence control unit, a subframe control unit and one or more subframe control switches; and
the data buffer conversion module comprises a bit conversion unit, an external data input port, a memory and one or more data transmission switches;
inputting input image data frame by frame, through the external data input port; and
storing the input image data in the memory.

21. The digital driving method according to claim 20, comprising:
converting a bit data format of the input image data through the bit conversion unit, so that bits of the input image data are aligned with the one or more data transmission switches and the one or more subframe control switches;
transmitting the bits of the input image data to one or more micro-LED pixels through the one or more data transmission switches; and
controlling a time sequence of the bits of the input image data through the time sequence control circuit module according to an image playback requirement.

22. The digital driving method according to claim 21, wherein a number of the one or more subframe control switches and a number of the one or more data transmission switches are the same, and the number is configured to be n=2^{k}, wherein k is a non-negative integer.

23. The digital driving method according to claim 22, wherein the number is 1, the bits of the input image data comprise a plurality of bits, and wherein transmitting the bits of the input image data to the one or more micro-LED pixels through the one or more data transmission switches comprises:
transmitting the plurality of bits of the input image data in the memory to the one or more micro-LED pixels in a position sequence or a random order of the plurality of bits through at least one of the one or more data transmission switches for display.

24. The digital driving method according to claim 23, wherein controlling the time sequence of the bits of the input image data through the time sequence control circuit module according to the image playback requirement comprises:
configuring the one or more subframe control switches according to weight of the plurality of bits of the input image data for driving and controlling of grayscale and brightness of an output display image.

25. The digital driving method according to claim 22, wherein the number is greater than 1, the bits of the input image data comprise a plurality of bits, and wherein transmitting the bits of the input image data to the one or more micro-LED pixels through the one or more data transmission switches comprises:
transmitting the plurality of bits of the input image data in the memory to the one or more micro-LED pixels according to weight of the plurality of the bits of the input image data through the one or more data transmission switches sequentially for display.

26. The digital driving method according to claim 25, wherein controlling the time sequence of the bits of the input image data through the time sequence control circuit module according to the image playback requirement comprises:
configuring the one or more subframe control switches sequentially according to weight of the plurality of bits of the input image data for driving and controlling of grayscale and brightness of an output display image.

27. The digital driving method according to claim 19, wherein configuring the one or more subframe control switches sequentially according to weight of the plurality of bits of the input image data comprises:
sequentially controlling a conduction time and a disconnection time of the one or more subframe control switches according to the weight of the plurality of bits of the input image data.

28. The digital driving method according to claim 20, wherein the conduction time of a respective one of the one or more subframe control switches is equal to a duty cycle of a respective one of the plurality of bits of the input image data.

29. The digital driving method according to claim 22, wherein the number is greater than 1, the bits of the input image data comprise a plurality of bits, and wherein transmitting the bits of the input image data to the one or more micro-LED pixels through the one or more data transmission switches comprises:
transmitting a first portion and a second portion sequentially of the plurality of bits of the input image data in the memory to the one or more micro-LED pixels through the one or more data transmission switches for display.
